(19) United States
(12) Patent Application Publication
(10) Pub. No.: US 2008/0277564 A1
(43) Pub. Date: Nov. 13, 2008

(54) System and Method of Controlling the Power of a Radiation Source

(75) Inventor: Xinyan Wu, Southampton (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,985

(22) PCT Filed: Nov. 13, 2006
(86) PCT No.: PCT/IB06/54203

§ 371 Date: May 8, 2008

(30) Foreign Application Priority Data
Nov. 14, 2005 (CN) 200510124721.4

(51) Int. Cl. G01J 1/32

(52) U.S. Cl. 250/205

(57) ABSTRACT

A system for controlling the power of a radiation source comprises a sensor FS, a feedback network FN and a radiation source power control circuit LPCC. The sensor receives a portion of a radiation beam LBP generated by a radiation source LS and provides an analogue signal AFS representative of a radiation source power. The feedback network FN is connected to the sensor FS. The radiation source power control circuit LPCC is connected to the feedback network FN and to the radiation source LS. The feedback network FN comprises a runlength compensating module RCM comprising:—a sampling module SM providing a digital signal DFS based on the analogue signal AFS,—at least one error controlling signal generator ECSG performing an amplitude compensation and providing at least one digital error controlling signal ECS to the radiation source power control circuit LPCC in order to control the power of the radiation source LS.

### FIELD OF THE INVENTION

An aspect of the invention relates to a data recording device. In particular, the present invention relates to a system for controlling the power of a radiation source used in a data recording device. A particular application of the invention relates to an optical data recording device using a laser for both reading and writing of data on an optical record carrier.

Another aspect of the invention relates to a method of controlling the power of a radiation source used in a data recording device.

### BACKGROUND OF THE INVENTION

The document US2002/0167980 discloses a laser driver with noise reduction feedback for optical storage applications. In order to provide a low noise laser beam, a noise reducing feedback network is provided which creates a noise reducing signal and provides that signal to the laser itself. In order to produce the noise reducing signal, the operation of the laser is monitored and the feedback signal is a direct result of this monitoring. Monitoring is accomplished by a fast-forward sense detector, which receives a portion of the laser beam from the operating laser. The output from this fast-forward sense detector is provided to an amplifier which inverts and amplifies the signal. A noise reduction feedback network then receives the amplified signal, appropriately filters this signal, and provides it to the laser itself so as to reduce noise in the laser-beam for the frequency band of importance for reading the recorded data from the optical medium. The noise reduction feedback signal further has sufficiently high impedance so as to not disturb the traditional continuous wave operation of the laser and to avoid interference with the traditional radio-frequency modulation of the laser.

However, the amplitude of the noise reduction feedback signal of this laser control system changes with the length of the marks or spaces (also called runlength) on the optical carrier track. In particular, such an amplitude change occurs during the recording of data, for example during the writing of the marks. This results in an unsatisfactory increase of the noise of the signal controlling the laser power.

### OBJECT AND SUMMARY OF THE INVENTION

It is an object of the invention to propose a system for controlling the power of a radiation source used in a data recording device that overcomes at least one of the drawbacks of the prior art, in particular that improves the laser power control.

According to an aspect of the invention, a radiation source power control system comprises a sensor receiving a portion of a radiation beam generated by a radiation source and providing an analogue signal representative of a radiation source power, a feedback network connected to the sensor, and a radiation source power control circuit connected to the feedback network and to the radiation source. The feedback network comprises a runlength compensating module comprising a sampling module providing a digital signal based on the analogue signal representative of the radiation source power, and at least one error controlling signal generator performing an amplitude compensation and providing at least one digital error controlling signal to the radiation source power control circuit in order to control the power of the radiation source.

The sampling module may comprise an analogue pre-processing module and an analogue to digital converter, the sampling module providing a digital signal representative of the radiation source power.

The error controlling signal generator may comprise an integrating and dividing module, a counting module, a lookup table module and a multiplicator. The integrating and dividing module and the counting module receives the digital signal representative of the radiation source power and at least one timing signal. The integrating and dividing module determines a sum by accumulating a plurality of samples of the digital signal representative of the radiation source power, while the counting module determines a runlength by counting the plurality of samples of the digital signal representative of the radiation source power during a duration based on the at least one timing signal. The integrating and dividing module calculates an average of the plurality of samples by dividing the sum by the runlength. The lookup table module coupled to the counting module determines a scaling factor based on the runlength. The multiplicator coupled to the lookup table module and the integrating and dividing module calculates a scaled value for the plurality of samples by multiplying the average of the plurality of sample with the scaling factor.

Optionally, the error controlling signal generator may further comprise at least one digital post-processing module connected to the multiplicator and providing a post-processed digital error controlling signal to the radiation source power control circuit.

Optionally, a time multiplexer may be connected between the multiplicator and at least one post-processing module, the time multiplexer receiving a delta timing signal and a threshold timing signal and providing a digital delta signal or a threshold signal to the radiation source power control circuit.

In a particular application, the radiation source is a laser diode generating a laser beam, and the sensor is an optical sensor. The optical sensor is a forward sense detector providing a forward sense analogue signal representative of the radiation source power.

According to another aspect of the invention, a data recording device comprises a radiation source generating a radiation beam directed toward a record carrier insertable into the data recording device. The data recording device comprises a radiation source power control system according to the invention coupled to the radiation source.

According to a further aspect of the invention, a method of control of a radiation source power comprises the steps of:
sensing a portion of a radiation beam generated by a radiation source and providing an analogue signal representative of a radiation source power,
sampling the analogue signal representative of the radiation source power and providing a digital signal representative of the radiation source power,
performing an amplitude compensation for a plurality of samples of the digital signal representative of the radiation source power and providing at least one digital error controlling signal to a radiation source power control circuit in order to control the power of the radiation source.

The amplitude compensation may comprise the steps of:
determining a sum by accumulating the plurality of samples of the digital signal representative of the radiation source power during a duration based on at least one timing signal,
determining a runlength by counting the plurality of samples of the digital signal representative of the radiation source power during a duration based on the at least one timing signal,
calculating an average of the plurality of samples by dividing the sum by the runlength,
determining a scaling factor based on the runlength,
calculating a scaled value for the plurality of samples by multiplying the average of the plurality of sample with the scaling factor, and generating at least one digital error controlling signal to a radiation source power control circuit in order to control the power of the radiation source.

Optionally, the method may further comprise the steps of amplifying the analogue signal representative of the radiation source power and cancelling an offset of the amplified analogue signal, and providing a modified analogue signal.

Optionally, the method may further comprise the step of post-processing the at least one digital error controlling signal.

In a particular application of the invention that relates to an optical data recording device using a laser for both reading and writing of data on an optical record carrier, the timing signal may consist in a delta timing signal and a threshold timing signal, while the digital error controlling signal may consist in a digital delta signal and a digital threshold signal.

According to still a further aspect, the invention relates to a computer program product for a radiation source control system, the computer program product comprising a set of instructions that, when loaded into the radiation source power control system, causes the radiation source control system to carry out the method according to the invention.

The invention allows a simple and efficient processing of the delta and threshold signals based on scaled forward sense samples in a digital implementation. In particular, the invention allows generating the digital threshold and delta signals for controlling the laser power drift, e.g. with respect to the temperature. Thus, the invention allows reducing the standard deviation or noise of the threshold and delta signals during the writing phase of the marks on the optical record carrier track.

The runlength compensating module of the laser controlling system according to the invention allows performing an amplitude compensation scheme in order to reduce the amplitude difference for different runlengths. Thus, with the invention, the recording performance and recording quality of the optical data recording device is improved.

Further, the digital implementation of the invention allows reducing the semiconductor process/geometry sensitivity, the power consumption and the silicon area of the laser power control circuit.

These and other aspects of the invention will be apparent from and elucidated with reference to the embodiments described hereinafter.

### BRIEF DESCRIPTION OF THE DRAWINGS

The present invention is illustrated by way of example and not limited to the accompanying figures, in which like references indicate similar elements:

FIG. 1 is a block diagram schematically and partially illustrating a recording device comprising a laser control system according to the invention,

FIG. 2 is a detailed block diagram schematically representing the runlength compensating module of the laser control system according to a first embodiment of the invention,

FIG. 3 illustrates a digital forward sense signal, a timing signal related to the delta signal and a timing signal related to the threshold signal,

FIG. 4 is a detailed block diagram schematically representing the runlength compensating module of the laser control system according to a second embodiment of the invention.

### DETAILED DESCRIPTION OF THE INVENTION

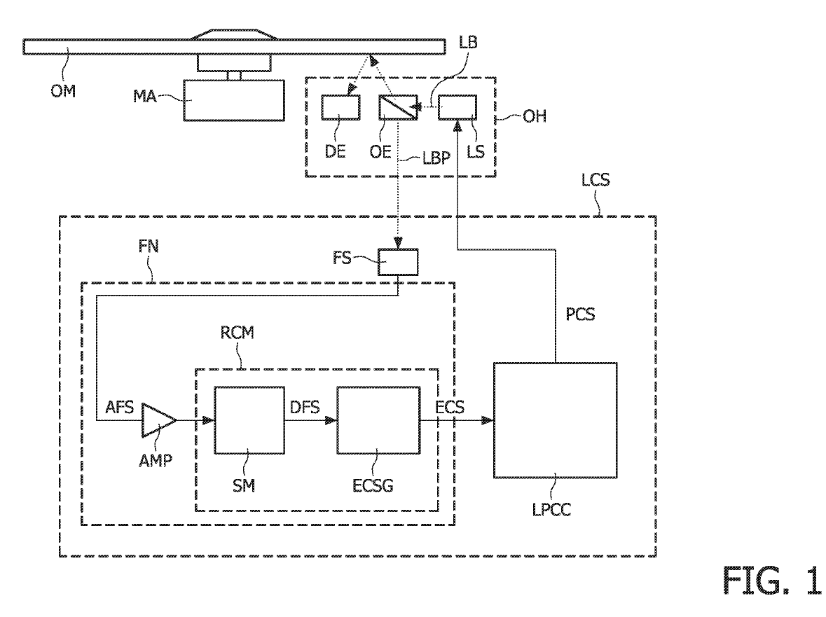

FIG. 1 is a block diagram schematically illustrating a data recording device comprising a laser power control system LCS of the invention.

The data recording device carries out operations that relates to both reading and writing of information on an optical record carrier OM.

The data recording device comprises a mechanical arrangement MA, an optical head OH and an electronic unit (partially shown).

An optical record carrier OM is shown inserted in the recording device. The optical record carrier OM may have a disk shape. The surface of the disk may comprise a single spiral circling from the inside of the disk to the outside of the disk. The binary information recorded on the track is represented by optically detectable portions, namely marks and spaces. The marks and spaces are detectable due to their different optical properties, e.g. variation in reflection of a radiation beam.

The mechanical arrangement MA, schematically and partially represented in FIG. 1, comprises a motor rotating the disk according to either a constant linear velocity mode or a constant angular velocity mode. The mechanical arrangement MA further comprises a track scanning servo control system (not shown) for correctly positioning the optical head OH with respect to the track. The mechanical circuit may further comprise a loading unit (not shown).

The optical head OH comprises radiation source LS, e.g. a laser diode, generating a radiation beam LB, e.g. a laser beam. The optical head OH also comprises various optical elements OE for guiding and focusing the laser beam, or a portion thereof, on the track of the optical record carrier OM. The optical head OH further comprises a detector DE, e.g. a four-quadrant diode, for detecting and measuring the laser beam reflected by the optically detectable portions on the optical record carrier OM track.

Typically, the electronic unit comprises a data encoder, a control unit, an interface circuit that are connected together through a bus, e.g. an I²C bus (these elements have been omitted in the Figures for clarity reasons), and a laser power control system LCS. The data encoder function is to encode and decode data according to predefined recording format. The data encoder provides signals used to write marks on the optical record carrier OM, and also timing signals. The control unit controls the scanning of the track of the optical record carrier OM and the reading of information based on commands from a consumer electronic device (audio device, video device, computer, television, etc . . . ). The interface circuit allows connecting the data recording device with other electronic circuits which are comprised in the consumer electronic device. The laser power control system LCS provides a laser power control signal PCS to the optical head OH in order to set the writing power of the laser source LS. Generally, a laser power control circuit operates in dependence of three input signals in order to control the laser power. The input signals are known as the delta signal, the threshold signal and the alpha signal. The alpha signal is a digital signal provided by the detector DE.

The laser power control system LCS comprises an optical sensor FS, a feedback network FN and a laser power control circuit LPCC.

The optical sensor FS receives a portion of a radiation beam LBP generated by a radiation source LS, for example a portion of the laser beam generated by the laser diode. The portion of the radiation beam LBP is provided by a beam splitter of the optical elements OE. The optical sensor FS may be a forward sense transducer FS. The forward sense transducer FS provides an analogue signal representative of the laser power AFS, namely an analogue forward sense signal.

The optical sensor FS is connected to the feedback network FN. An output of the feedback network FN is connected to the laser power control circuit LPCC.

The feedback network FN comprises a runlength compensating module RCM. The runlength compensating module RCM comprises a sampling module SM and an error controlling signal generator ECSG. The sampling module SM provides a digital signal DFS based on the analogue signal representative of the laser power AFS. The error controlling signal generator ECSG carries out operations for performing an amplitude compensation that will be explained in more details hereinafter. The error controlling signal generator ECSG provides at least one digital error signal ECS to the laser power control circuit LPCC in order to control the power of the laser source LS.

The feedback network FN may further comprise an amplification module AMP connected between the optical sensor FS and the runlength compensating module RCM.

An output of the laser power control circuit LPCC is connected to the laser source LS. The laser power control circuit LPCC provides a laser power control signal PCS. In particular, the laser power control signal PCS may be used to set the writing power of the laser source LS.

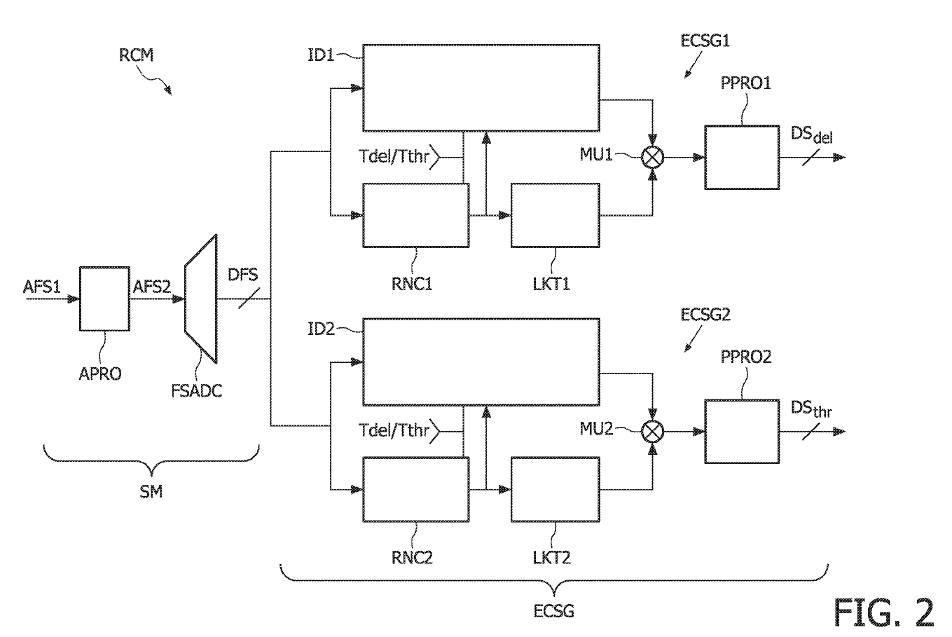

FIG. 2 is a detailed block diagram schematically representing the runlength compensating module RCM of the laser control system LCS according to a first embodiment of the invention.

The runlength compensating module RCM comprises a sampling module SM and an error controlling signal generator ECSG.

The sampling module SM comprises an analogue pre-processing module APRO and a forward sense analogue to digital converter FSADC. The analogue pre-processing module APRO amplifies the analogue forward sense signal AFS1 provided by the forward sense transducer FS. It may also perform an offset cancellation of the analogue forward sense signal. The modified analogue forward sense signal AFS2 is digitized by the forward sense analogue to digital converter FSADC. The analogue to digital converter FSADC may be a six or eight bits high frequency analogue to digital converter. The sampling module SM provides a digital forward sense signal DFS to the error controlling signal generator ECSG.

The error controlling signal generator ECSG comprises a delta signal generator ECSG1 and a threshold signal generator ECSG2. The delta signal generator ECSG1 comprises a first integrating and dividing module ID1, a first counting module RNC1, a first lookup table module LKT1 and a first multiplicator MU1. The delta signal generator may further comprise a first post-processing module PPRO1. The threshold signal generator ECSG2 comprises a second integrating and dividing module ID2, a second counting module RNC2, a second lookup table module LKT2 and a second multiplicator MU2. The threshold signal generator may further comprise a second post-processing module PPRO2.

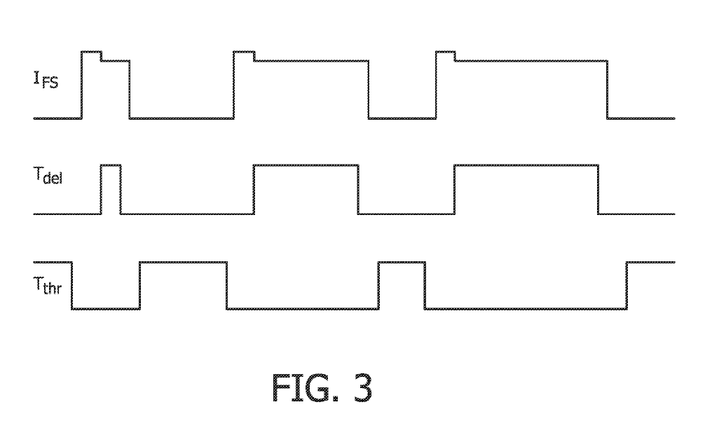

FIG. 3 illustrates, from top to bottom, a digital forward sense signal (current intensity I_{FS}), a timing signal related to the delta signal T_{del} and a timing signal related to the threshold signal Tₜₕᵣ, respectively.

Typically, the delta timing signal and the threshold timing signal are not in a “high” state (namely binary 1), or conversely in a “low” state (namely binary 0) at the same time.

The delta signal generator ECSG1, shown in FIG. 2, carries out the operations for generating a digital delta signal DS_{del}.

The first integrating and dividing module ID1 and the first counting module RNC1 are connected together. Both receive the digital forward sense signal DFS from the sampling module SM and the timing signals T_{del}, Tₜₕᵣ. An input of the first lookup table module LKT1 is connected to an output of the first counting module RNC1. An input of the first multiplicator MU1 is connected to the outputs of the first integrating and dividing module ID1 and the first lookup table module LKT1. The first post-processing module PPRO1 is connected to an output of the first multiplicator MU1.

When the delta timing signal T_{del} is in a high state, a plurality of samples of the digital forward sense signal DFS is accumulated by the first integrating and dividing module ID1.

When the delta timing signal T_{del} changes into a low state, the first counting module RNC1 determines a runlength.

The runlength corresponds to a mark on the optical record carrier OM track that has been scanned by the laser beam. The first integrating and dividing module ID1 determines a sum corresponding to the runlength. The corresponding sum is stored in a sum register. Then, the first integrating and dividing module ID1 calculates an average of the samples of the digital forward sense signal DFS. This calculation consists in dividing the sum by the runlength. Simultaneously, the first lookup table module LKT1 determines a first scaling factor matching to the corresponding runlength. Then, the first multiplicator MU1 calculates a scaled value of the samples of the digital forward sense signal. This calculation consists in multiplying the average of the samples of the digital forward sense signal with the first scaling factor.

Subsequently, the first post-processing module PPRO1 may further post-process the scaled value in order to generate the digital delta signal DS_{del}. The first post-processing module PPRO1 may comprise a low pass filtering module and gain stage module.

Finally, the first integrating and dividing module ID1 is dumped, in particular the sum register is reset waiting for the next delta signal processing.

The threshold signal generator ECSG2, shown in FIG. 2, carries out the operations for generating a digital threshold signal DSₜₕᵣ. The digital threshold signal DSₜₕᵣ can be calculated according to a succession of steps which are similar to the delta signal calculation explained hereinbefore.

The second integrating and dividing module ID2 and the second counting module RNC2 are connected together. Both receive the digital forward sense signal DFS from the sampling module SM and the timing signals T_{del}, Tₜₕᵣ. An input of the second lookup table module LKT2 is connected to an output of the second counting module RNC2. An input of the second multiplicator MU2 is connected to the outputs of the second integrating and dividing module ID2 and the second lookup table module LKT2. The second post-processing module PPRO2 is connected to an output of the second multiplicator MU2.

When the threshold timing signal Tₜₕᵣ is in a high state, a plurality of samples of the digital forward sense signal DFS is accumulated by the second integrating and dividing module ID2.

When the threshold timing signal Tₜₕᵣ changes into a low state, the second counting module RNC2 determines a runlength corresponding to a scanned mark. The second integrating and dividing module ID2 determines a sum corresponding to the runlength. The corresponding sum is stored in a sum register. Then, the second integrating and dividing module ID2 calculates an average of the samples of the digital forward sense signal. This calculation consists in dividing the sum by the runlength. Simultaneously, the second lookup table module LKT2 determines a second scaling factor matching to the corresponding runlength. Then, the second multiplicator MU2 calculates a scaled value of the samples of the digital forward sense signal. This calculation consists in multiplying the average of the samples of the digital forward sense signal with the second scaling factor.

Subsequently, the second post-processing module PPRO2 may further post-process the scaled value in order to generate the digital threshold signal DSₜₕᵣ. The second post-processing module PPRO2 may comprise a low pass filtering module and gain stage module.

Finally, the second integrating and dividing module ID2 is dumped, in particular the sum register is reset waiting for the next threshold signal processing.

Advantageously, the low-pass filtering module of the first PPRO1 and second PPRO2 post-processing module is a tuned module designed to pass all frequencies below a cut-off frequency which is determined and optimized for a particular laser power control system LCS.

Advantageously, the scaling factors that are stored in the lookup table module (the first LKT1 or the second LKT2 lookup table module) are determined by the analogue bandwidth of the feedback network FN and the recording speed. The lookup table modules are calibrated once for a particular laser power controlling system of a data recording device.

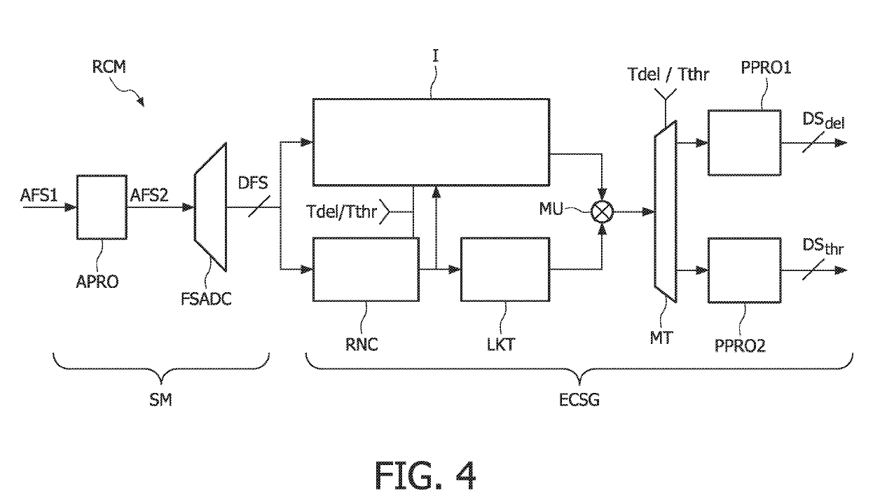

FIG. 4 is a block diagram schematically representing the runlength compensating module RCM of the laser control system LCS according to a second embodiment of the invention. The second embodiment takes into account that the delta timing signal T_{del} and the threshold timing signal Tₜₕᵣ are not in a high state, conversely a low state, at the same time (see FIG. 3). The second embodiment differs from the first embodiment in that the runlength compensating module RCM for the delta signal DS_{del} and the threshold signal DSₜₕᵣ shares the same hardware, in particular the same error controlling signal generator ECSG.

The error controlling signal generator ECSG comprises an integrating and dividing module ID, a counting module RNC, a lookup table module LKT, a multiplicator MU and a multiplexer MT.

The integrating and dividing module ID and the counting module RNC are connected together. Both receive the digital forward sense signal DFS from the sampling module SM and the delta and threshold timing signal T_{del}, Tₜₕᵣ. An input of the lookup table module LKT is connected to an output of the counting module RNC. An input of the multiplicator MU is connected to the outputs of the integrating and dividing module ID and the lookup table module LKT. The multiplexer MT is a time multiplexer. It is connected to an output of the multiplicator MU and receives the timing signals T_{del}, Tₜₕᵣ. The multiplexer MT takes into account the delta timing signal T_{del} and the threshold timing signal Tₜₕᵣ for providing the digital delta signal DS_{del} or the digital threshold signal DSₜₕᵣ to the laser power control circuit LPCC, respectively.

The error controlling signal generator ECSG may further comprise a delta post-processing module PPRO1 and a threshold post-processing module PPRO2 connected to the multiplexer MT. Alternatively, the error controlling signal generator ECSG may further comprise a single post-processing module (not shown) connected between the multiplicator MU and the multiplexer MT.

The error controlling signal generator ECSG carries out the operations for generating the digital delta signal DS_{del} or the digital threshold signal DSₜₕᵣ according to a succession of steps which are similar to the delta signal and the threshold signal calculation/generation explained hereinbefore with respect to the first embodiment, respectively. Thus, these operations will not be further described.

As an example, the laser efficiency or the power-current characteristics of the laser source LS will be reduced when the temperature increases. Typically, data writing operations require important laser power. Thus, the power dissipation on the optical record carrier OM increases during data writing operations. This leads to large variations of the ambient temperature in the laser source LS area. Due to the bandwidth limitation of the laser power control system LCS, the amplitude of the analogue forward sense signal AFS will change with the length of marks or spaces. The runlength compensating module RCM will compensate the large variation of the analogue forward sense signal AFS and will provide the digital delta signal DS_{del} and the digital threshold signal DSₜₕᵣ to the laser power control circuit. The laser power controlling circuit will provide a power controlling signal PCS based on said digital delta DS_{del} and threshold DSₜₕᵣ signals to the laser source. In particular, the laser power control circuit LPCC will increase the current of the power controlling signal PCS provided to the laser source LS in order to compensate for the power loss. This allows maintaining a substantially constant laser power and a constant recording performance.

It will be apparent for a person skilled in the art that the error controlling signal generator ECSG, ECSG1, ECSG2 may be a system software program that is stored in a program memory of the laser power control circuit LPCC. The system software program comprises a set of instructions that defines one or more functions of the error controlling signal generator ECSG, ECSG1, ECSG2, which the laser power control circuit LPCC carries out. Alternatively, the error controlling signal generator ECSG, ECSG1, ECSG2 may be in the form of an electronic circuit that carries out one or more functions, which are hardware-defined rather than software defined. In such an implementation, respective elements of the circuit and respective connections between these elements define the one or more functions that the error controlling signal generator ECSG, ECSG1, ECSG2 carries out. Further, the runlength compensating module RCM may be implemented in a single integrated circuit, for example in the laser power control circuit LPCC.

It will be apparent for a person skilled in the art that the optical record carrier OM designates, for example, any compact disk CD or any digital versatile disk DVD or any future recording disk supporting a wide range of recordable and rewritable optical formats (e.g. CD-R, CD-RW, DVD+R/−R, DVD+RW/−RW, DVR, DVD Write-Once, etc . . . ). In addition, any information, for example audio, video or data information, may be recorded on such an optical record carrier. Further, the laser source may emit a laser beam which frequency is adapted and compliant with the optical record carrier.

The drawings and their description hereinbefore illustrate rather than limit the invention. Any reference sign in a claim should not be construed as limiting the claim. The word “comprising” does not exclude the presence of other elements than those listed in a claim. The word “a” or “an” preceding an element does not exclude the presence of a plurality of such element.

1. A radiation source power control system comprising
a sensor (FS) receiving a portion of a radiation beam (LBP) generated by a radiation source (LS) and providing an analogue signal (AFS) representative of a radiation source power,
a feedback network (FN) connected to the sensor (FS),
a radiation source power control circuit (LPCC) connected to the feedback network (FN) and to the radiation source (LS),
wherein the feedback network (FN) comprises a runlength compensating module (RCM) comprising:
a sampling module (SM) providing a digital signal (DFS) based on the analogue signal (AFS) representative of the radiation source power,
at least one error controlling signal generator (ECSG, ECSG1, ECSG2) performing an amplitude compensation and providing at least one digital error controlling signal (ECS) to the radiation source power control circuit (LPCC) in order to control the power of the radiation source (LS).

2. A radiation source power control system according to claim 1, wherein the sampling module (SM) comprises an analogue pre-processing module (APRO) and an analogue to digital converter (FSADC), the sampling module (SM) providing a digital signal (DFS) representative of the radiation source power.

3. A radiation source power control system according to claim 1, wherein the error controlling signal generator (ECSG, ECSG1, ECSG2) comprises:
an integrating and dividing module (ID, ID1, ID2),
a counting module (RNC, RNC1, RNC2),
a lookup table module (LKT, LKT1, LKT2)
a multiplicator (MU, MU1, MU2),
wherein:
the integrating and dividing module (ID, ID1, ID2) and the counting module (RNC, RNC1, RNC2) receives the digital signal DFS representative of the radiation source power and at least one timing signal (T_{del}, Tₜₕᵣ), the integrating and dividing module (ID, ID1, ID2) determining a sum by accumulating a plurality of samples of the digital signal DFS representative of the radiation source power, and the counting module (RNC, RNC1, RNC2) determining a runlength by counting the plurality of samples of the digital signal (DFS) representative of the radiation source power during a duration based on the at least one timing signal (T_{del}, Tₜₕᵣ), the integrating and dividing module (ID, ID1, ID2) calculating an average of the plurality of samples by dividing the sum by the runlength,
the lookup table module (LKT, LKT1, LKT2) coupled to the counting module (RNC, RNC1, RNC2) determines a scaling factor based on the runlength,
the multiplicator (MU, MU1, MU2) coupled to the lookup table module (LKT, LKT1, LKT2) and the integrating and dividing module (ID, ID1, ID2) calculates a scaled value for the plurality of samples by multiplying the average of the plurality of sample with the scaling factor.

4. A radiation source power control system according to claim 3, wherein the error controlling signal generator (ECSG, ECSG1, ECSG2) further comprises at least one digital post-processing module (PPRO1, PPRO2) connected to the multiplicator (MU, MU1, MU2) and providing a post-processed digital error controlling signal (DS_{del}, DSₜₕᵣ) to the radiation source power control circuit (LPCC).

5. A radiation source power control system according to claim 3, wherein a time multiplexer (MT) is connected between the multiplicator (MU1, MU2) and at least one post-processing module (PPRO1, PPRO2), the time multiplexer (MT) receiving a delta timing signal (T_{del}) and a threshold timing signal (Tₜₕᵣ) and providing a digital delta signal (DS_{del}) or a digital threshold signal (DSₜₕᵣ) to the radiation source power control circuit (LPCC).

6. A radiation source power control system according to claim 1, wherein the radiation source (LS) is a laser diode generating a laser beam (LB), and the sensor (FS) is an optical sensor.

7. A radiation source power control system according to claim 1, wherein the sensor (FS) is a forward sense transducer providing a forward sense analogue signal (AFS) representative of the radiation source power.

8. A method of control of a radiation source power comprising the step of:
sensing a portion of a radiation beam (LB) generated by a radiation source (LS) and providing an analogue signal (AFS) representative of a radiation source power,
sampling the analogue signal (AFS) representative of the radiation source power and providing a digital signal (DFS) representative of the radiation source power,
performing an amplitude compensation for a plurality of samples of the digital signal representative of the radiation source power and providing at least one digital error controlling signal (ECS, DS_{del}, DSₜₕᵣ) to a radiation source power control circuit (LPCC) in order to control the power of the radiation source (LS).

9. A method according to claim 8, wherein the step of performing an amplitude compensation comprises the steps of:
determining a sum by accumulating the plurality of samples of the digital signal representative of the radiation source power during a duration based on at least one timing signal (T_{del}, Tₜₕᵣ),
determining a runlength by counting the plurality of samples of the digital signal representative of the radiation source power during a duration based on the at least one timing signal (T_{del}, Tₜₕᵣ),
calculating an average of the plurality of samples by dividing the sum by the runlength,
determining a scaling factor based on the runlength,
calculating a scaled value for the plurality of samples by multiplying the average of the plurality of sample with the scaling factor, and generating at least one digital error controlling signal (ECS, DS_{del}, DSₜₕᵣ) to a radiation source power control circuit (LPCC) in order to control the power of the radiation source (LS).

10. A method according to the claim 8, wherein the method further comprises the steps of:
amplifying the analogue signal (AFS1) representative of the radiation source power cancelling an offset of the amplified analogue signal,
providing a modified analogue signal (AFS2).

11. A method according to anyone of the claims 8, wherein the method further comprises the step of post-processing the at least one digital error controlling signal.

12. A method according to anyone of the claims 8, wherein the at least one timing signal consists in a delta timing signal (T_{del}) and a threshold timing signal (Tₜₕᵣ), and the at least one digital error controlling signal (ECS) consists in a digital delta signal (DS_{del}) and a digital threshold signal (DSₜₕᵣ).

13. A data recording device comprising a radiation source (LS) generating a radiation beam (LB) directed toward a data record carrier (OM) insertable into the data recording device, wherein the data recording device comprises a radiation source power control system (LCS) according to claim 1 coupled to the radiation source (LS).

14. A computer program product for a radiation source control system, the computer program product comprising a set of instructions that, when loaded into the radiation source power control system (LCS), causes the radiation source control system (LCS) to carry out the various steps of:
sensing a portion of a radiation beam (LB) generated by a radiation source (LS) and providing an analogue signal (AFS) representative of a radiation source power,
sampling the analogue signal (AFS) representative of the radiation source power and providing a digital signal (DFS) representative of the radiation source power,
performing an amplitude compensation for a plurality of samples of the digital signal representative of the radiation source power and providing at least one digital error controlling signal (ECS, DS_{del}, DSₜₕᵣ) to a radiation source power control circuit (LPCC) in order to control the power of the radiation source (LS).
